(19) United States
(12) Patent Application Publication
(10) Pub. No.: US 2015/0301372 A1
(43) Pub. Date: Oct. 22, 2015

(54) LIQUID CRYSTAL DISPLAY DEVICE

(71) Applicant: SHARP KABUSHIKI KAISHA, Osaka-shi, Osaka (JP)

(72) Inventor: Takahiro MORI, Osaka (JP)

(73) Assignee: Sharp Kabushiki Kaisha, Osaka (JP)

(21) Appl. No.: 14/647,437

(22) PCT Filed: Nov. 20, 2013
(86) PCT No.: PCT/JP2013/081230

§ 371 Date: May 26, 2015

(30) Foreign Application Priority Data
Nov. 27, 2012 (JP) 2012-258766

(51) Int. Cl. G02F 1/1339; G02F 1/1345; G02F 1/1343

(52) U.S. Cl. CPC G02F 1/1339; G02F 1/1343; G02F 1/1345

(57) ABSTRACT

The present invention provides a liquid crystal display device with a narrow frame region and high display quality. The liquid crystal display device of the present invention is provided with: a first substrate that has a first electrode and a third electrode; and a second substrate that has a second electrode and a fourth electrode. The first electrode has a first main wire part and a first lead-out part, the third electrode has a third main wire part and a third lead-out part, and the first main wire part and the third main wire part are disposed between a sealing member and a display region. The first lead-out part, the second electrode, the third lead-out part, and the fourth electrode partially overlap the sealing member, the first main wire part is electrically connected to the second electrode via the first lead-out part and a first conductive member, the third main wire part is electrically connected to the fourth electrode via the third lead-out part and a second conductive member, and potentials having mutually opposite polarities are respectively supplied to the first electrode and the third electrode.

### TECHNICAL FIELD

The present invention relates to a liquid crystal display device, and more particularly, to a liquid crystal display device that is provided with an ion adsorption electrode to reduce deterioration in display quality due to impurity ions.

### BACKGROUND ART

Drive systems in liquid crystal displays include twisted nematic (TN) or other vertical electric field types and in-plane switching (IPS) or other horizontal electric field types. A vertical electric field type liquid crystal display has a pixel electrode on one of a pair of opposing substrates, and a common electrode on the other. A horizontal electric field type liquid crystal display has the pixel electrode and the common electrode on one substrate. By applying a voltage between the pixel electrode and the common electrode, a field is formed in a vertical direction relative to the substrate in the liquid crystal layer in the vertical electric field type, and a field is formed in a horizontal direction relative to the substrate in the liquid crystal layer in the horizontal electric field type. Thus, a liquid crystal display controls the orientation of liquid crystal molecules by controlling the field formed in the liquid crystal layer, and performs a display by adjusting the transmittance of light.

The liquid crystal display is generally provided with an array substrate, and a color filter substrate disposed opposite the array substrate. The array substrate and the color filter substrate are bonded using a sealing member, and a liquid crystal material is injected into a region surrounded by the sealing member to form a liquid crystal layer. When a voltage is applied to the liquid crystal layer when driving the liquid crystal display, there are instances when impurity ions mixed into the liquid crystal material and impurity ions eluted into the liquid crystal layer from the sealing member diffuse into the display region, flocculate, and cause the display quality of the liquid crystal display to deteriorate.

To prevent the deterioration of display quality brought on by impurity ions such as these, measures for preventing contamination, such as high-level cleaning of apparatus for injecting the liquid crystal material, or measures such as using highly reliable sealing members that suppress the elution of impurity ions are being studied to enhance the purity of the liquid crystal material. Furthermore, the arrangement of an ion adsorption electrode between the opposing electrodes and the sealing member to cause the impurity ions to be adsorbed to the ion adsorption electrode is also being studied (Refer to Patent Document 1, for example).

### RELATED ART DOCUMENT

### Patent Document

Patent Document 1: Japanese Patent Application Example Laid-Open Publication No. 2010-26032

### SUMMARY OF THE INVENTION

### Problems to be Solved by the Invention

The trend in recent years in electronic equipment that makes use of liquid crystal display devices has been toward wider display regions and narrower frame regions. Generally speaking, in order to make the frame region narrower, the widths of the respective wires, such as the common electrode wiring formed in the array substrate, the gate wiring, and the source wiring, are scaled down. However, the scaling down of the widths of these wires has its limits.

With the aforementioned situation in mind, an object of the present invention is to provide a liquid crystal display device having a narrow frame region and high display quality.

### Means for Solving the Problems

The inventor examined methods of reducing the impact on the display region resulting from the influx of impurity ions into the liquid crystal layer, and focused on a method of adsorbing impurity ions of both polarities by providing two ion adsorption electrodes and supplying potentials having a different polarity to each thereof.

FIG. 20 is a cross-sectional schematic of a liquid crystal display device disclosed in Patent Document 1. As shown in FIG. 20, the liquid crystal display device 500 disclosed in Patent Document 1 has two transparent substrates 501 and 502 that are disposed opposite one another with a liquid crystal layer 520 therebetween, and a sealing member 503 that is disposed in proximity to the outer periphery of the transparent substrates 501 and 502, and bonds the transparent substrates 501 and 502. The transparent substrate 501 has an opposite electrode 504, and an ion adsorption electrode 505 that has been disposed outside the display region between the opposite electrode 504 and the sealing member 503. The transparent substrate 502 has a switching element 508, a gate signal line 509, a source signal line 510, a pixel electrode 511, and a dummy pixel electrode 514. The transparent substrate 502, and the switching element and various types of wiring formed thereon constitute an array substrate. The dummy pixel electrode 514 is formed outside the display region in a region opposite to the ion adsorption electrode 505. The liquid crystal display device 500 can respectively adsorb ion impurities of both polarities by supplying potentials of opposite polarity to the dummy pixel electrode 514 and the ion adsorption electrode 505.

As a result of the examination by the inventor, it was discovered that although the liquid crystal display device 500 disclosed in the aforementioned Patent Document 1 is able to adsorb ion impurities of both polarities, the dummy pixel electrode 514 formed on the array substrate becomes an obstacle when it comes to narrowing the frame region. Then it was discovered that the display quality of the liquid crystal display device can be enhanced and the frame region can be narrowed by integrating two ion adsorption electrodes into an opposite substrate that has been disposed so as to oppose an array substrate with a liquid crystal layer therebetween, and supplying potentials having mutually different polarities to each thereof. In addition, it was discovered that the frame region could be reduced further by bonding the two substrates using a conductive member in the sealing member region, thereby doing away with the need to use a conductive paste, a conductive seal, or the like to connect the ion adsorbing electrode to an external terminal on the outer side of the sealing member region.

Thus, the inventor conceived of a way to skillfully solve for the aforementioned problem and arrived at the present invention.

A first aspect of the present invention is a liquid crystal display device having a display region and a frame region, including: a first substrate and a second substrate that face each other; a sealing member that bonds the first substrate to the second substrate; and a liquid crystal layer sealed by the sealing member, wherein the sealing member is formed so as to surround the display region, wherein the first substrate has a first electrode and a third electrode within the frame region on a surface of the first substrate facing the liquid crystal layer, wherein the second substrate has a second electrode and a fourth electrode within the frame region on a surface of the second substrate facing the liquid crystal layer, wherein the first electrode has a first main wire part and a first lead-out part, wherein the third electrode has a third main wire part and a third lead-out part, wherein the first main wire part and the third main wire part are respectively disposed between the sealing member and the display region, wherein a portion of the first lead-out part, a portion of the second electrode, a portion of the third lead-out part, and a portion of the fourth electrode respectively overlap the sealing member, wherein the first main wire part is electrically connected to the second electrode via the first lead-out part and a first conductive member, wherein the third main wire part is electrically connected to the fourth electrode via the third lead-out part and a second conductive member, wherein the first lead-out part and the second electrode are electrically connected at a location that differs from a connection point of the third lead-out part and the fourth electrode, and wherein potentials having mutually opposite polarities are respectively supplied to the first electrode and the third electrode.

There are no special requirements for other components as long as such components are formed as essential parts of the configuration of the liquid crystal display device of the present invention.

The second electrode and the fourth electrode may each connect to a direct-current power source.

The sealing member may include a plurality of conductive particles, the first conductive member may be at least one of the plurality of conductive particles, and the second conductive member may be at least one of the plurality of conductive particles.

The first main wire part may be formed so as to surround the display region.

The third main wire part may be formed so as to surround the display region.

The first main wire part and the third main wire part may be disposed in the same layer.

The first substrate may further include a fifth electrode within the frame region on a surface of the first substrate facing the liquid crystal layer, the second substrate may further include a sixth electrode within the frame region on a surface of the second substrate facing the liquid crystal layer, the fifth electrode may have a fifth main wire part and a fifth lead-out part, the fifth main wire part may be disposed on an outer side of the sealing member, a portion of the fifth lead-out part and a portion of the sixth electrode may respectively overlap the sealing member, the fifth main wire part may be electrically connected to the sixth electrode via the fifth lead-out part and a third conductive member, and the fifth lead-out part and the sixth electrode may be electrically connected at a location that differs from the connection point of the first lead-out part and the second electrode and the connection point of the third lead-out part and the fourth electrode.

The sealing member may include a plurality of conductive particles, and the third conductive member may be at least one of the plurality of conductive particles.

The sixth electrode may be supplied with a potential that differs from that of the second electrode and/or the fourth electrode.

The sixth electrode may be connected to ground.

The first substrate may further include a fifth electrode on a surface of the first substrate facing the liquid crystal layer, the fifth electrode may have a fifth main wire part and a fifth lead-out part, the fifth main wire part may be disposed on an outer side of the sealing member, a portion of the fifth lead-out part may overlap the sealing member, and the fifth electrode may be electrically connected to either the second electrode or the fourth electrode via the fifth lead-out part and a third conductive member.

The sealing member may include a plurality of conductive particles, and the third conductive member may be at least one of the plurality of conductive particles.

The fifth main wire part may be formed so as to surround the display region.

The fifth main wire part may be disposed in the same layer as the first main wire part and the third main wire part.

The first substrate may further include a seventh electrode on a surface of the first substrate opposite to the liquid crystal layer, and the seventh electrode may be supplied with a potential that differs from that of the second electrode and/or the fourth electrode.

The seventh electrode may be connected to ground.

The seventh electrode may be formed so as to cover the display region.

The second substrate may further include a common electrode and a pixel electrode in the display region.

A conductive paste can be given as another example of the first conductive member, the second conductive member, the third conductive member, and the fourth conductive member.

### Effects of the Invention

According to the present invention, a liquid crystal display device having a narrow frame region and high display quality is achieved.

### BRIEF DESCRIPTION OF THE DRAWINGS

FIG. 1 is plan view schematically showing a liquid crystal display device according to Embodiment 1.

FIG. 2 is a cross-sectional view taken along the line A-B of the liquid crystal display device shown in FIG. 1.

FIG. 3 is a flowchart showing steps according to a vacuum injection method of manufacturing a liquid crystal display device according to Embodiment 1.

FIG. 4 is a flowchart showing steps according to a liquid crystal dripping method of manufacturing a liquid crystal display device according to Embodiment 1.

FIG. 5 is a plan view schematically showing a liquid crystal display device according to Application Example 1.

FIG. 6 is a cross-sectional view taken along the line C-D of the liquid crystal display device shown in FIG. 5.

FIG. 7 is a plan view schematically showing a liquid crystal display device according to Embodiment 2.

FIG. 8 is a cross-sectional view taken along the line E-F of the liquid crystal display device shown in FIG. 7.

FIG. 9 is a plan view schematically showing a liquid crystal display device according to Embodiment 3.

FIG. 10 is a cross-sectional view taken along the line G-H of the liquid crystal display device shown in FIG. 9.

FIG. 11 is a plan view schematically showing a liquid crystal display device according to Application Example 2.

FIG. 12 is a cross-sectional view taken along the line I-J of the liquid crystal display device shown in FIG. 11.

FIG. 13 is a plan view schematically showing a liquid crystal display device according to Embodiment 4.

FIG. 14 is a cross-sectional view taken along the line K-L of the liquid crystal display device shown in FIG. 13.

FIG. 15 is a flowchart showing steps of a vacuum injection method of manufacturing a liquid crystal display device according to Embodiment 4.

FIG. 16 is a flowchart showing steps of a liquid crystal dripping method of manufacturing a liquid crystal display device according to Embodiment 4.

FIG. 17 is a plan view schematically showing a liquid crystal display device according to Embodiment 5.

FIG. 18 is a cross-sectional view taken along the line M-N of the liquid crystal display device shown in FIG. 17.

FIG. 19 is a flowchart showing steps of a vacuum injection method of manufacturing a liquid crystal display device according to Embodiment 5.

FIG. 20 is a cross-sectional view schematically showing a liquid crystal display device disclosed in Patent Document 1.

### DETAILED DESCRIPTION OF EMBODIMENTS

The present invention will be described in more detail below by citing the embodiments and referring to the drawings, but the present invention is not limited solely to these embodiments.

A liquid crystal display device of the present invention can exhibit excellent display characteristics by being used in a display apparatus, such as a television set, a personal computer, a cell phone, and an information display, for example.

### Embodiment 1

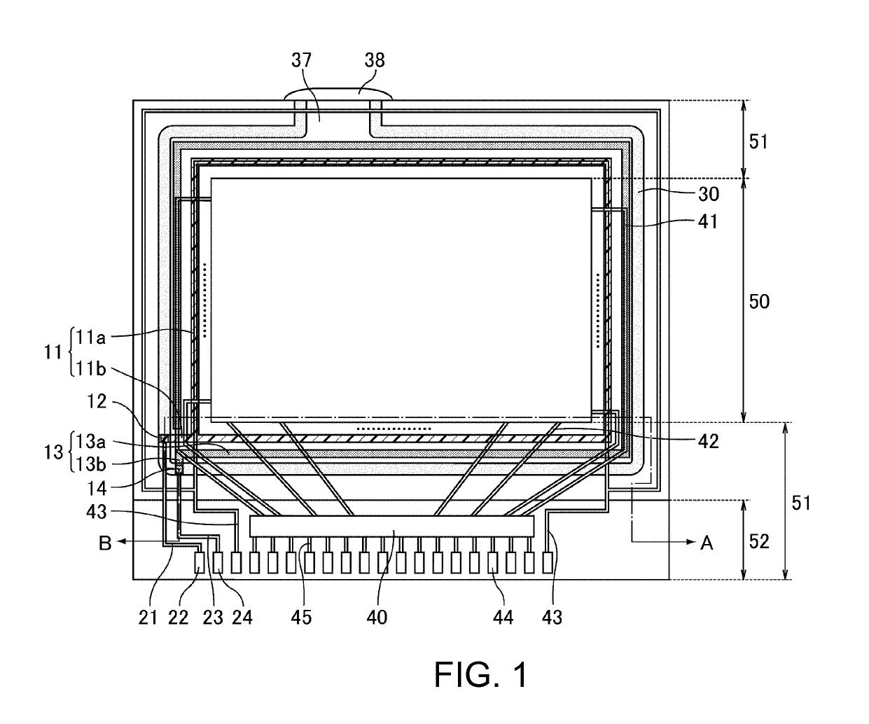

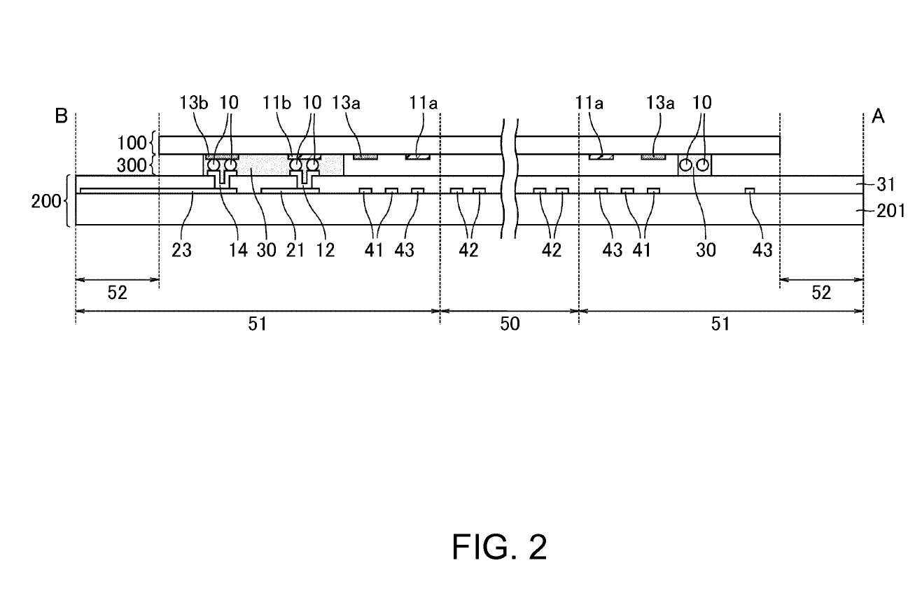

An example of a liquid crystal display device according to Embodiment 1 will be described below. FIG. 1 is a plan view schematically showing the liquid crystal display device according to Embodiment 1. FIG. 2 is a cross-sectional view taken along line A-B of the liquid crystal display device shown in FIG. 1.

As shown in FIG. 1, the liquid crystal display device according to Embodiment 1 has a display region 50 and a frame region 51. The display region 50 is the region that contributes to display, and when the liquid crystal display device is driven, is the region where light from a light source, such as a backlight unit, passes through and an observer visually recognizes an image. The frame region 51 is formed around the display region 50. The frame region 51 includes a terminal region 52.

As shown in FIG. 2, the liquid crystal display device according to Embodiment 1 has a color filter substrate (first substrate) 100 and an array substrate (second substrate) 200 that are opposite one another, a sealing member 30 that bonds the color filter substrate 100 and the array substrate 200 together, and a liquid crystal layer 300 formed in a region surrounded by the sealing member 30. In Embodiment 1, a backlight unit (not shown), the array substrate 200, the liquid crystal layer 300, and the color filter substrate 100 are arranged in this order from the backside toward the viewer side of the liquid crystal display device.

As shown in FIG. 1, the sealing member 30 is disposed so as to surround the display region 50. When forming the liquid crystal layer 300 using a vacuum injection method, a liquid crystal injection opening 37 is formed in a portion of the sealing member 30, and after the liquid crystal material has been injected, this opening 37 is sealed using a sealing agent 38. When forming the liquid crystal layer 300 using a liquid crystal dripping method (one drop fill (ODF)), the sealing member 30 is formed so as to completely surround the display region 50 without forming a liquid crystal injection opening 37 in the sealing member 30. Any sealing member 30 that is cured using heat, cured by irradiation by ultraviolet light, or cured by either heat or ultraviolet light irradiation may be used. A sealing agent 38 that is cured by being irradiated by ultraviolet light can be used. The sealing member 30 includes a plurality of conductive particles 10 as a conductive member. Metallic particles, metal-coated particles, and so forth can be used as the conductive particles 10. The conductive particles 10 introduced into the sealing member 30, for example, are 0.5 percent by weight of the entire sealing member 30.

Although not shown in the drawing, the color filter substrate 100 is provided with an insulating transparent substrate that is made from a material such as glass, and a color filter and black matrix that are formed on the transparent substrate. As shown in FIGS. 1 and 2, the color filter substrate 100 has a first electrode 11 and a third electrode 13 on a surface of the side facing the liquid crystal layer 300 within the frame region 51. The first electrode 11 and the third electrode 13 are ion adsorption electrodes. There are no special limitations on the first electrode and the third electrode, which can be formed in accordance with patterning after having formed a thin film using indium tin oxide (ITO), tin dioxide (SnO₂), or other such conductive materials having optical transparency, for example.

The first electrode 11 has a first main wire part 11a and a first lead-out part 11b, and the third electrode 13 has a third main wire part 13a and a third lead-out part 13b. The first main wire part 11a and the third main wire part 13a are respectively disposed between the sealing member 30 and the display area 50, and a portion of the first lead-out part 11b and a portion of the third lead-out part 13b are respectively superimposed on the sealing member 30. It is preferable that the first main wire part 11a and the third main wire part 13a be disposed in the same layer.

In the plan view, the first main wire part 11a and the third main wire part 13a are both partially bent straight line shapes, and are formed so as to surround the display region 50. The formation of the first and third main wire parts 11a and 13a so as to surround the display region 50 is more preferable than being partially formed because impurity ions can thus be adsorbed along substantially the entire circumference of the display region 50.

It is preferable that the first electrode 11 and the third electrode 13 be disposed so as not to overlap with the display region 50 in the plan view. The use of a configuration such as this makes it possible to suppress the occurrence of quality problems, such as a deterioration of the contrast ratio of the liquid crystal display device, due to the effect on an electric field generated between the first electrode 11 and the third electrode 13. Specifically, when driving the liquid crystal display device, it is possible to suppress the effect on the electric field formed between a pixel electrode (not shown) and a common electrode (not shown) formed within the display region 50.

Furthermore, the first main wire part 11a and the third main wire part 13a are disposed so as not to overlap with the sealing member 30 in the plan view. In Embodiment 1, a portion of the first lead-out part 11b, a portion of a second electrode 12, a portion of the third lead-out part 13b, and a portion of a fourth electrode 14 are respectively superimposed on the sealing member 30, and a portion of the first lead-out part 11b and a portion of the second electrode 12 are disposed so as to be opposite one another in the cross-sectional view, and a portion of the third lead-out part 13b and a portion of the fourth electrode 14 are disposed so as to be opposite one another in the cross-sectional view. Therefore, the adhesion between the color filter substrate 100 and the array substrate 200 becomes weak in the section where the portion of the first lead-out part 11b and the portion of the second electrode 12 are opposite one another, and in the section where the portion of the third lead-out part 13b and the portion of the fourth electrode 14 are opposite one another. When the first electrode 11 and the third electrode 13 are formed using the aforementioned ITO and the like, the adhesion between the color filter substrate 100 and the array substrate 200 becomes even weaker. Therefore, by reducing the portions of the electrodes that are superimposed on the sealing member 30, it is possible to make it harder for the two substrates to peel apart, and to make it harder for liquid crystal leakage and other such quality-related problems to occur even when a physical force has been applied to the liquid crystal display device from outside.

In the connection point between the first electrode and the second electrode, and the connection point between the third electrode and the fourth electrode, the first lead-out part 11b is formed so as to be wider than the second electrode 12, and the third lead-out part 13b is formed so as to be wider than the fourth electrode 14. The first lead-out part 11b and the third lead-out part 13b can be made 50 μm wide, and the second electrode 12 and the fourth electrode 14 can be made 40 μm wide, for example.

Furthermore, it is preferable that sufficient distance be secured between the first lead-out part 11b and the third lead-out part 13b on the sealing member 30 so that the respective connection points lack are not electrically conductive with each other. Specifically, it is preferable that the distance between the first lead-out part 11b and the third lead-out part 13b be equal to or greater than 50 μm.

The array substrate 200 has an insulating transparent substrate 201 that is made from a material such as glass, and has a plurality of gate lines 41 and a plurality of source lines 42 formed on the transparent substrate 201. A region surrounded by adjacent gate lines 41 and source lines 42 is a pixel, and a pixel electrode (not shown) is formed for each pixel. A thin film transistor (TFT) (not shown), which is a switching element, is provided in the vicinity of an intersection of a gate line 41 and a source line 42. The pixels are arranged in a matrix in the display region 50 of the array substrate 200, and contribute to display.

As shown in FIGS. 1 and 2, the gate lines 41, source lines 42, and common electrode wiring 43 are provided in the frame region 51. A driver IC 40 for controlling the TFTs, an FPC terminal 44, and a connection wiring 45 for linking the driver IC 40 and the FPC terminal 44 are provided in the terminal region 52. An FPC terminal 44 is connected to both ends of the common electrode wiring 43. The gate lines 41 and the source lines 42 extend from the display region 50 to the terminal region 52, and are connected to the driver IC 40. As shown in FIG. 2, an insulating film 31 is formed on the common electrode wiring 43, the connection wiring 45, the gate lines 41, and the source lines 42.

As shown in FIG. 2, the array substrate 200 has the second electrode 12 and the fourth electrode 14 on a surface of the side facing the liquid crystal layer 300 within the frame region 51. As shown in FIG. 1, a portion of the second electrode 12 and a portion of the fourth electrode 14 are respectively superimposed on the sealing member 30. There are no special limitations on the material, shape, method of manufacturing, and so forth of the second electrode 12 and the fourth electrode 14, and can be formed using indium tin oxide (ITO), tin dioxide (SnO₂), or other such conductive materials having optical transparency in accordance with patterning at the same time as the pixel electrodes (not shown) are formed, for example.

The second electrode 12 is connected via opposite electrode wiring 21 to a terminal 22 formed in the terminal region 52. The fourth electrode 14 is connected via opposite electrode wiring 23 to a terminal 24 formed in the terminal region 52. The terminal 22 supplies required potential to the second electrode 12, and the terminal 24 supplies required potential to the fourth electrode 14. The terminals 22 and 24 are FPC terminals, for example, and are connected to a direct-current power source.

A portion of the first lead-out part 11b and a portion of the second electrode 12, and a portion of the third lead-out part 13b and a portion of the fourth electrode 14 are respectively opposite one another in the cross-sectional view. The first main wire part 11a is electrically connected to the second electrode 12 via the first lead-out part 11b and conductive particles (first conductive member) 10. The third main wire part 13a is electrically connected to the fourth electrode 14 via the third lead-out part 13b and conductive particles (second conductive member) 10. The first lead-out part 11b and the second electrode 12 are electrically connected at a location that differs from the connection point of the third lead-out part 13b and the fourth electrode 14.

Required potential is supplied to the first electrode 11 from the terminal 22 via the opposite electrode wiring 21, the second electrode 12, and the conductive particle 10. Required potential is supplied to the second electrode 12 from the terminal 24 via the opposite electrode wiring 23, the fourth electrode 14, and the other conductive particle 10. Potentials having a polarity that are opposite to one another are supplied to the first electrode 11 and the third electrode 13. This makes it possible to adsorb impurity ions of both polarities mixed into the liquid crystal layer 300, and impurity ions of both polarities eluted from the sealing member 30.

A method of driving the liquid crystal display device according to Embodiment 1 will be explained below. When a display signal is inputted from the FPC terminal 44 to the driver IC 40, a gradation signal corresponding to the display signal is supplied to the source line 42 at the same time as a scan signal corresponding to the display signal is supplied to the gate line 41. The scan signal controls the ON/OFF of a TFT. A common potential is supplied to the common electrode via the common electrode wiring 43. When a signal potential is supplied from a TFT to a pixel electrode in a state where the common electrode has maintained the common potential, a prescribed voltage is applied to the liquid crystal layer 300 and an electrical field is formed.

In a vertical electric field-type liquid crystal display device, the pixel electrodes are formed on the array substrate 200, and the common electrode is formed on the color filter substrate 100. Therefore, when a voltage is applied to the pixel electrode and the common electrode, an electrical field that is vertical relative to the surfaces of both substrates is formed in the liquid crystal layer 300. In a horizontal electric field-type liquid crystal display device, the pixel electrodes and the common electrode are formed on the array substrate 200, and the pixel electrodes and the common electrode is disposed so as to be opposite one another in the plan view. In the horizontal electric field type, the pixel electrodes and the common electrode are formed only on the array substrate 200 without being formed on the color filter substrate 100. When a voltage is applied between a pixel electrode and the common electrode, an electrical field that is horizontal relative to the surfaces of both substrates is formed in the liquid crystal layer 300. As described above, the orientation of the liquid crystal molecules is controlled by controlling the electrical field formed in the liquid crystal layer 300, and a display is performed by adjusting the transmittance of the light.

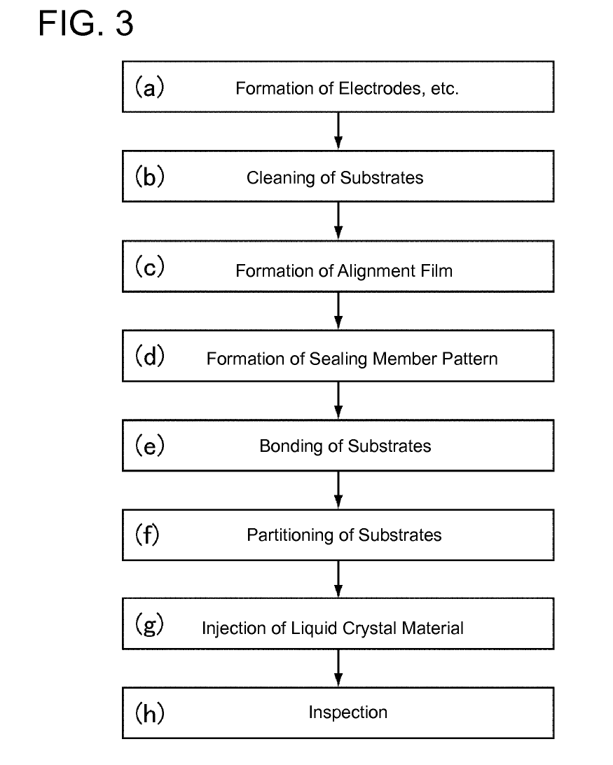

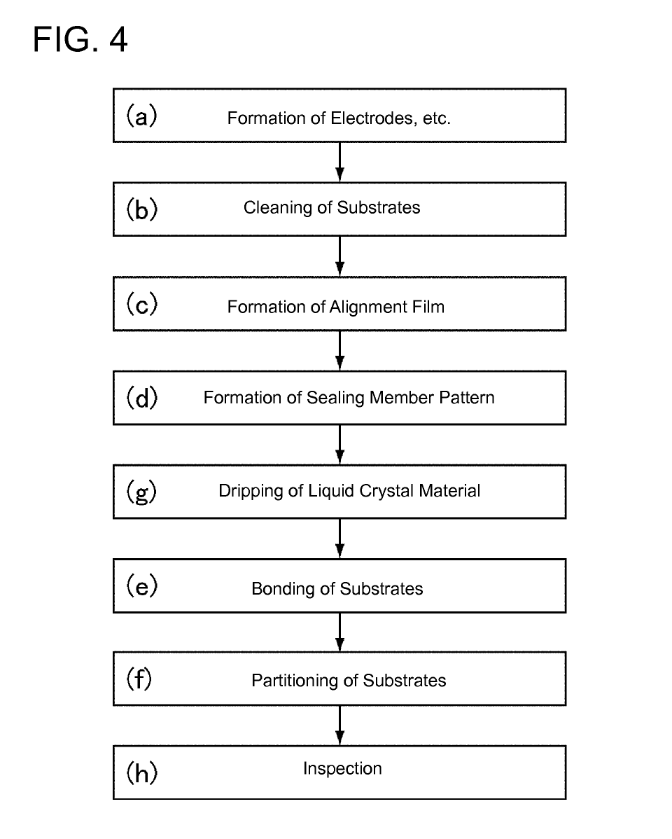

A method of manufacturing the liquid crystal display device according to Embodiment 1 will be explained below using FIGS. 3 and 4. FIGS. 3 and 4 are flowcharts showing steps of manufacturing the liquid crystal display device according to Embodiment 1, FIG. 3 showing manufacturing steps according to a vacuum insertion method, and FIG. 4 showing manufacturing steps according to a liquid crystal dripping method.

As shown in FIG. 3, in the steps of manufacturing according to the vacuum injection method, first of all, prescribed electrodes, wiring, and so forth are respectively formed on the color filter substrate 100 and the array substrate 200 (Step (a)). The color filter substrate 100 and the array substrate 200 are cleaned (Step (b)), and an alignment film is formed on the surfaces of the cleaned color filter substrate 100 and array substrate 200 (Step (c)). Thereafter, a sealing member 30 pattern is formed on either one of the color filter substrate 100 or the array substrate 200 (Step (d)), and the two substrates are bonded to one another (Step (e)). The bonded substrates are cut to a required size, and partitioned into a plurality of liquid crystal cells (Step (f)). A liquid crystal layer is formed by injecting a liquid crystal materials between the color filter substrate 100 and the array substrate 200 (Step (g)).

In the vacuum injection method, patterning is performed so that a liquid crystal injection opening 37 is formed when the sealing member is formed (Step (d)), the color filter substrate 100 and the array substrate 200 are bonded together in an environment having lower pressure than normal atmospheric pressure (Step (e)), and thereafter, the liquid crystal material is injected between the two substrates by releasing the vacuum and restoring normal atmospheric pressure (Step (g)). Thereafter, the liquid crystal layer 300 is formed by sealing the liquid crystal injection opening 37 using a sealing agent 38.

Thereafter, the backlight unit, the driver, and so forth are mounted, and the liquid crystal display device is complete. Lastly, in an inspection step, a panel lighting test and the like are performed individually, and the quality status of the product is confirmed (Step (h)).

In Embodiment 1, subsequent to the step of bonding the two substrates, the color filter substrate 100 and the array substrate 200 are bonded via a sealing member that includes conductive particles 10, and therefore are electrically connected to one another at least partially. Therefore, the task of bonding a conductive tape or the like when performing a simple lighting test prior to product completion becomes unnecessary, and reductions in number of manufacturing steps and components can be realized.

After cleaning the substrates in Step (b), the color filter substrate 100 and the array substrate 200 may be heated, and a step (degassing step) that removes organic solvents, gases, and so forth may be performed, for example. As an example of Step (d) that forms the sealing member pattern, a method of forming a pattern using a method of dispensing a paste-like sealing material, a printing method, and so forth will be given.

In a manufacturing step according to the liquid crystal dripping method (ODF), after having formed a pattern using a sealing material so as to surround a display region in one of the substrates without forming a liquid crystal injection opening 37 (Step (d)), as shown in FIG. 4, a liquid crystal material is dripped (Step (g)), and thereafter the liquid crystal layer 300 is formed in accordance with bonding the one substrate to the other substrate (Step (e)). Steps (a) to (c), (f) and (h) are the same as the manufacturing steps according to the vacuum injection method.

### Application Example 1

Application Example 1 is an application of Embodiment 1. In Application Example 1, the shape of a first main wire part and a third main wire part are changed.

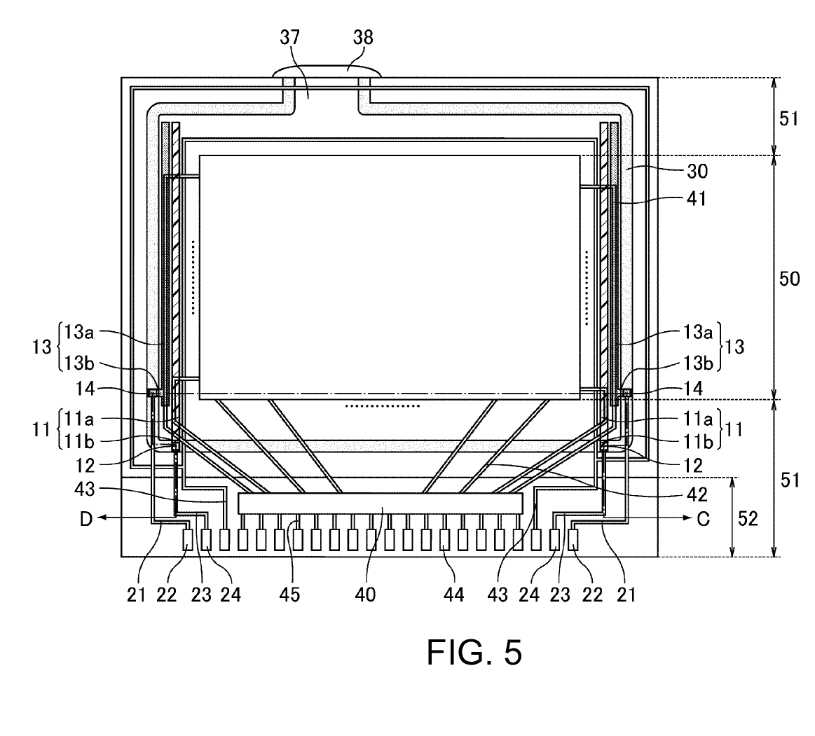

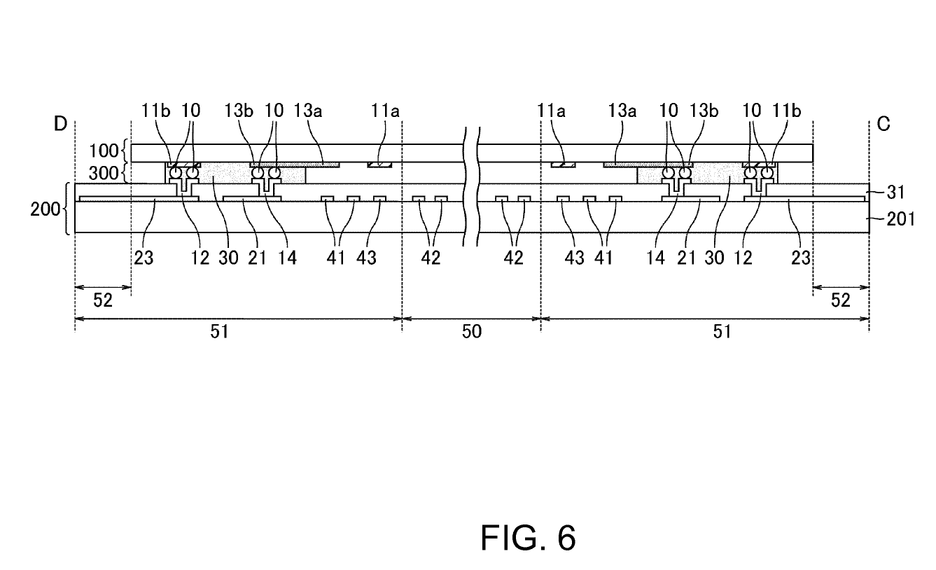

An example of a liquid crystal display device according to Application Example 1 will be described below. FIG. 5 is a plan view schematically showing a liquid crystal display device according to Application Example 1. FIG. 6 is a cross-sectional view taken along line C-D of the liquid crystal display device shown in FIG. 5.

As shown in FIG. 5, in Application Example 1, one each of a first main wire part 11a and a third main wire part 13a is respectively formed along one side of a display region 50, and, in addition, one each is respectively formed along one side that is the opposite side of the display region 50. Two first main wire parts 11a and two third main wire parts 13a are respectively disposed between the sealing member 30 and the display region 50, and a portion of a first lead-out part 11b and a portion of a third lead-out part 13b are respectively superimposed on the sealing member 30. As shown in FIG. 6, the array substrate 200 has one each of a second electrode 12 and a fourth electrode 14 within each of the frame regions 51 that are opposite one another with the display region therebetween.

As shown in FIG. 6, the two first main wire parts 11a are each respectively electrically connected to different second electrodes 12 via the first lead-out part 11b and conductive particles (first conductive member) 10. The two third main wire parts 13a are also each respectively electrically connected to different fourth electrodes 14 via the third lead-out part 13b and conductive particles (second conductive member) 10. In accordance with Application Example 1, it is also possible to adsorb impurity ions of both polarities mixed into the liquid crystal layer 300, and impurity ions of both polarities eluted from the sealing member 30.

Other components of the liquid crystal display device according to Embodiment 1 will be explained in detail.

A conductive material, such as aluminum, or copper can be used in the gate lines 41, the source lines 42, the common electrode wiring 43, and the connection wiring 45. These wiring groups are obtained by patterning after having formed a thin film of the conductive material, for example. A conductive material having optical transparency, such as ITO, or tin dioxide (SnO₂) can be used in the pixel electrodes and the common electrode. It is preferable that the insulating film 31 have light transmittance characteristics.

A polarizing plate is respectively provided on the sides of the color filter substrate 100 and array substrate 200 opposite to the liquid crystal layer. A retardation plate may also be disposed on these polarizing plates, and the polarizing plate may be a circularly polarizing plate. In addition, either on organic alignment film or an inorganic alignment film may be formed on the liquid crystal layer 300-side surfaces of the color filter substrate 100 and the array substrate 200.

A color filter can be formed using an acrylic resin or the like that has been mixed with a pigment, for example, and a black matrix can be formed using an acrylic resin that has been mixed with a black pigment, chromium, or the like. The black matrix is around 1.0 μm thick, for example.

The TFT may be a bottom-gate-type or a top-gate-type. Amorphous silicon (a-Si) and so forth is used as the material in the semiconductor layer of the TFT, but it is preferable that an oxide semiconductor such as indium gallium zinc oxide be used. This makes it possible for electron mobility to be enhanced, and for the TFT to be made smaller. In addition, because off-leakage current is low, a long-term charge can be held, and low-frequency drive becomes possible.

A liquid crystal material having characteristics (dielectric anisotropy) that align the liquid crystal molecules in a specific direction in accordance with a fixed voltage being applied is injected into the liquid crystal layer 300. The orientation of the liquid crystal molecules inside the liquid crystal layer 300 is controlled by applying a voltage of equal to or larger than a threshold.

The configuration of the electrodes in the liquid crystal display device according to Embodiment 1 can be confirmed by disassembling the liquid crystal display device (cell phone, monitor, liquid crystal TV (television), or information display) and observing the electrode configuration under a microscope. The inclusion of conductive particles in the sealing member can also be confirmed using a microscope.

According to Embodiment 1, it is possible to obtain a liquid crystal display device that has a narrow frame region and high display quality.

### Embodiment 2

Embodiment 2 is the same as Embodiment 1 except for additionally having a fifth electrode and a sixth electrode on the outer side of the sealing member.

Embodiment 2 can be suitably used in an IPS, FFS, or other such horizontal electrical field-type liquid crystal display device. A horizontal electric field type differs from a vertical electric field type, such as the TN type, in that the color filter substrate is in a floating state. Therefore, static electricity readily builds up inside the liquid crystal display device in accordance with the color filter substrate being touched. There is a danger of the liquid crystal orientation changing due to externally generated static electricity such as this, thereby causing a deterioration of display quality.

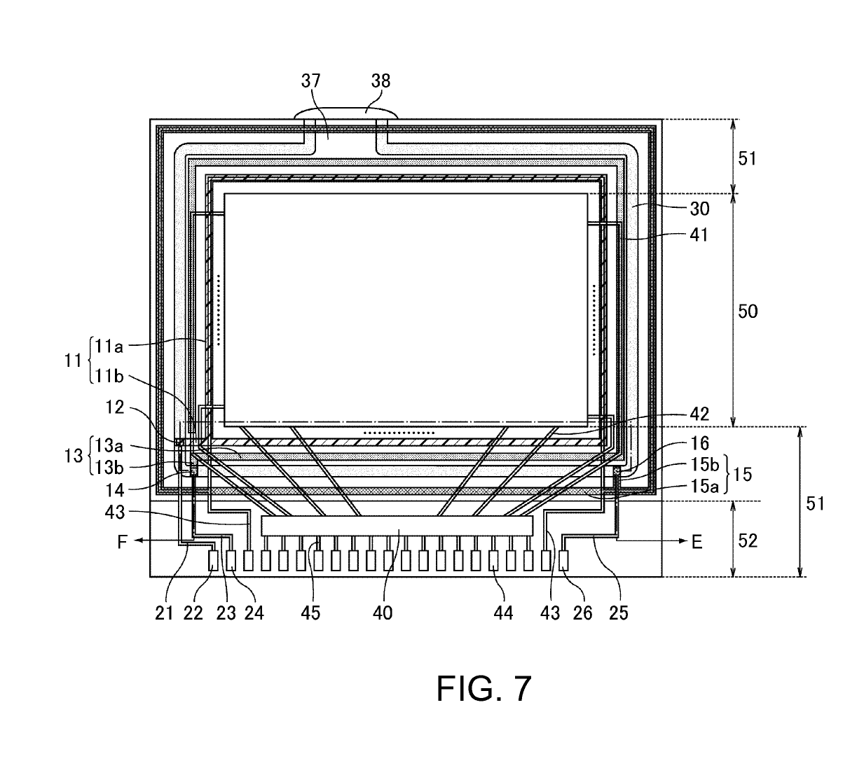

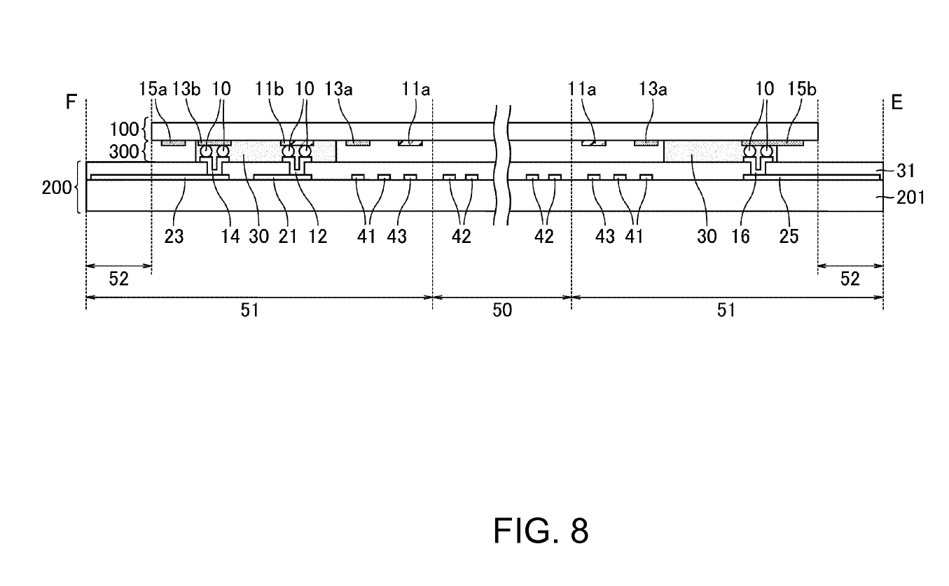

An example of a liquid crystal display device according to Embodiment 2 will be described below. FIG. 7 is a plan view schematically showing the liquid crystal display device according to Embodiment 2. FIG. 8 is a cross-sectional view taken along line E-F of the liquid crystal display device shown in FIG. 7. The same members as those in Embodiment 1 are given the same reference characters, and the description thereof will not be repeated.

As shown in FIGS. 7 and 8, in Embodiment 2, the color filter substrate 100 further has a fifth electrode 15 on a surface of the side facing the liquid crystal layer 300 within the frame region 51. The fifth electrode 15 has a fifth main wire part 15a and a fifth lead-out part 15b. The fifth main wire part is disposed on a side farther away from the display region relative to the sealing member, that is, on the outer side of the sealing member. There are no special limitations, and the fifth electrode 15 can be formed using indium tin oxide (ITO), tin dioxide (SnO₂), or other such conductive materials having optical transparency, for example. The fifth electrode 15 can be formed at the same time that the first electrode 11 and the third electrode 13 are formed.

The second substrate 200 further has a sixth electrode 16 on a surface of the side facing the liquid crystal layer 300 within the frame region 51. The sixth electrode 16 can be formed in the same manner using the same materials as the second electrode 12 and the fourth electrode 14. A portion of the fifth lead-out part 15b and a portion of the sixth electrode 16 are respectively superimposed on the sealing member 30. The fifth main wire part 15a is electrically connected to the sixth electrode 16 via the fifth lead-out part 15b and conductive particles (third conductive member) 10. The fifth lead-out part 15b and the sixth electrode 16 are electrically connected at a location that differs from the connection point of the first lead-out part 11b and the second electrode 12, and the connection point of the third lead-out part 13b and the fourth electrode 14. The fifth lead-out part 15b is formed so as to be wider than the sixth electrode 16 at the connection point of the fifth electrode 15 and the sixth electrode 16. The fifth electrode lead-out part 15b can be 50 μm wide, and the sixth electrode 16 can be 40 μm wide.

The sixth electrode 16 is connected via opposite electrode wiring 25 to an FPC terminal 26 formed in the terminal region 52. A required potential is supplied to the fifth electrode 15 from the FPC terminal 26 via the opposite electrode wiring 25, the sixth electrode 16, and the conductive particles 10. The sixth electrode 16 is supplied with a potential that differs from those of the second electrode 12 and/or the fourth electrode 14. The sixth electrode can be connected to ground (0V), for example. This makes it possible to allow externally generated static electricity to escape to the array substrate 200. The arrangement of the fifth main wire part 15a on the outer side of the sealing member 30 makes it possible to prevent static electricity from damaging the gate lines and other wiring groups, the pixel electrode, and so forth when the static electricity is allowed to escape to the array substrate 200.

The fifth main wire part 15a is a partially bent straight line shape, and is formed to surround the display region. The formation of the fifth main wire part 15a so as to surround the display region 50 is more preferable than being partially formed because externally generated static electricity can thus be allowed to escape to the array substrate 200 along substantially the entire circumference of the color filter substrate 100. It is preferable that the fifth main wire part 15a be disposed in the same layer as the first main wire part 11a and the third main wire part 13a. Furthermore, it is preferable that the distance between the fifth lead-out part 15b and the first lead-out part 11b on the sealing member 30, and the distance between the fifth lead-out part 15b and the third lead-out part 13b be equal to or greater than 50 μm, respectively. The use of a configuration such as this makes it possible to prevent continuity between the respective connection points.

Embodiment 2 can allow externally generated static electricity to escape without the need for a shielding electrode, a conductive pad, conductive paste, and so forth similar to Embodiment 4 described below. Therefore, the frame region can be made even narrower. In addition, the materials and manufacturing steps for forming the shielding electrode and so forth are unnecessary, which makes it possible to enhance manufacturing efficiency and reduce manufacturing costs.

According to Embodiment 2, it is possible to achieve a liquid crystal display device having a narrow frame region and high display quality in the same manner as Embodiment 1. In addition, it is possible to maintain even higher display quality because it is harder for static electricity to build up inside the liquid crystal display device.

### Embodiment 3

Embodiment 3 is the same as Embodiment 1 except for having a fifth electrode on the outer side of a sealing member, and the fact that the fifth electrode and a third electrode are electrically connected. Embodiment 3 differs from Embodiment 2 in that the fifth electrode and the third electrode are electrically connected, but shares in common with Embodiment 2 the fact of having the fifth electrode on the outer side of the sealing member. Embodiment 3 can be suitably used in an IPS, FFS, or other such horizontal electrical field-type liquid crystal display device.

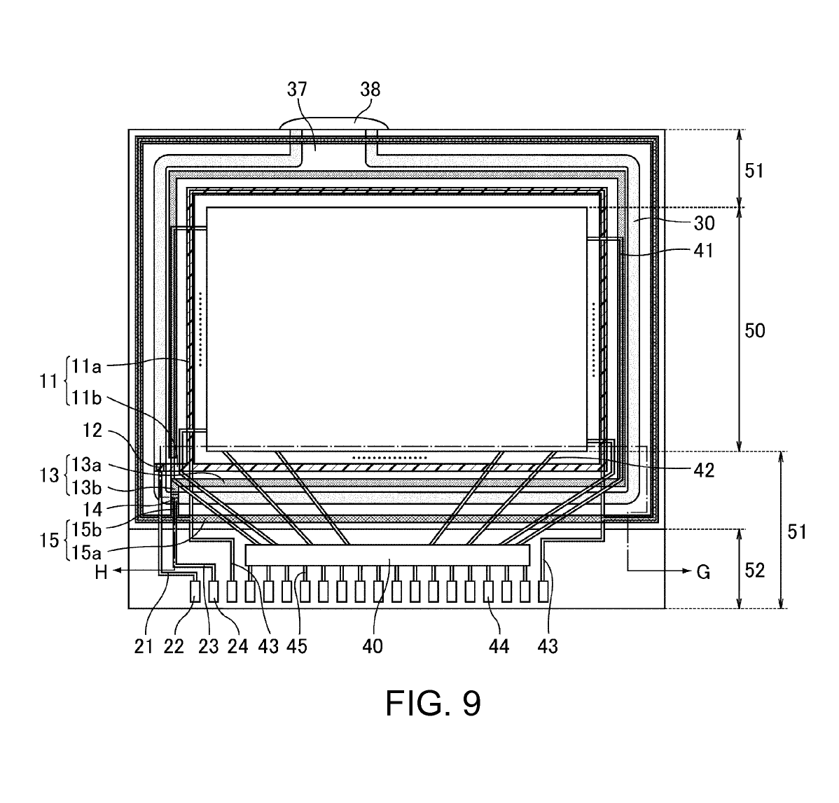

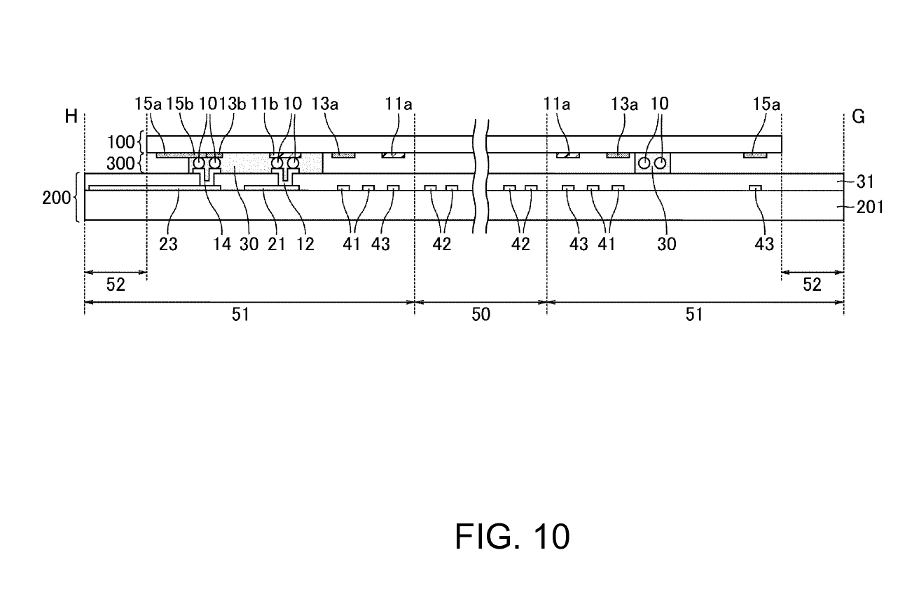

An example of a liquid crystal display device according to Embodiment 3 will be described below. FIG. 9 is a plan view schematically showing the liquid crystal display device according to Embodiment 3. FIG. 10 is a cross-sectional view taken along line G-H of the liquid crystal display device shown in FIG. 9. The same members as those in Embodiment 1 are given the same reference characters, and the description thereof will not be repeated.

As shown in FIGS. 9 and 10, in Embodiment 3, the color filter substrate 100 further has a fifth electrode 15 on a surface of the side facing the liquid crystal layer 300 within the frame region 51. The configuration of the fifth electrode 15 is the same as that of Embodiment 2. A portion of the fifth lead-out part 15b is superimposed on the sealing member 30, and a portion of the fifth lead-out part 15b and a portion of the fourth electrode 14 are opposite one another in the cross-sectional view. The fifth electrode 15 is electrically connected to the fourth electrode 14 via the fifth lead-out part 15b and conductive particles (third conductive particles) 10. By using a configuration such as this, the same potential as the potential supplied to the third electrode is supplied to the fifth electrode 15.

The fifth electrode 15 can allow static electricity that has accumulated inside the liquid crystal display device to escape to the array substrate 200.

### Application Example 2

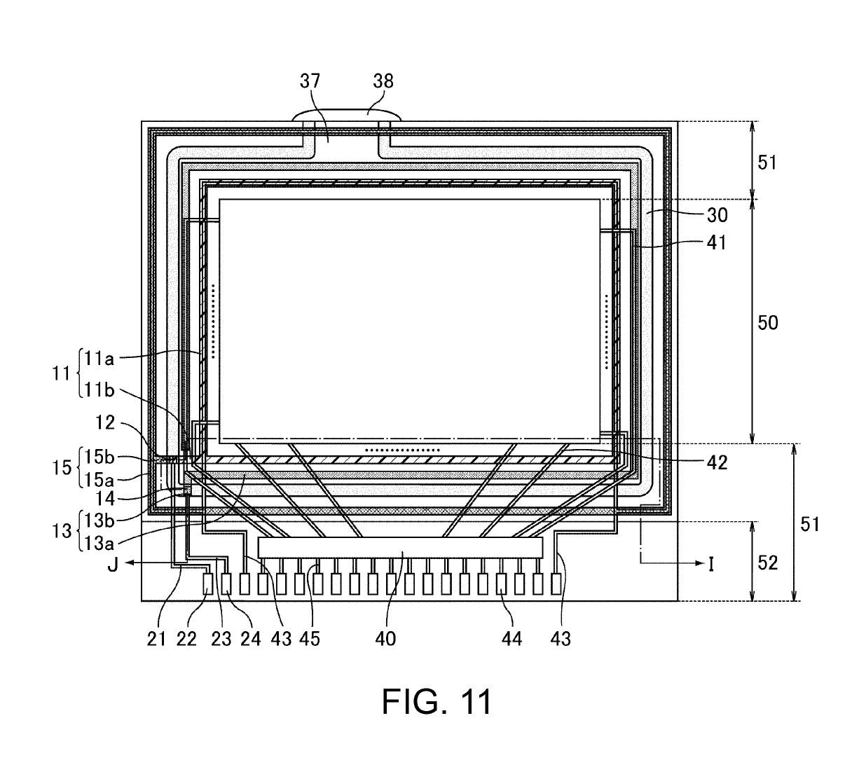

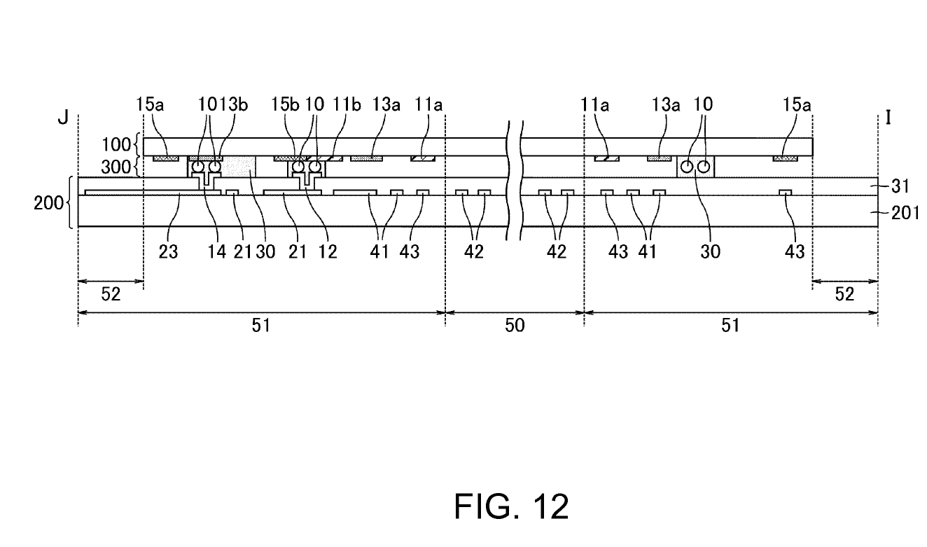

Application Example 2 is an application of Embodiment 3. FIG. 11 is a plan view schematically showing the liquid crystal display device of Application Example 2. FIG. 12 is a cross-sectional view taken along line I-J of the liquid crystal display device shown in FIG. 11. The same members as those in Embodiment 1 are given the same reference characters, and the description thereof will not be repeated. As shown in FIGS. 11 and 12, in Application Example 2, a portion of the fifth lead-out part 15b is superimposed on the sealing member 30, and a portion of the fifth lead-out part 15b and a portion of the second electrode 12 are opposite one another in the cross-sectional view. The fifth electrode 15 is electrically connected to the second electrode 12 via the fifth lead-out part 15b and conductive particles (third conductive particles) 10. By using a configuration such as this, the same potential as the potential supplied to the first electrode is supplied to the fifth electrode 15.

Embodiment 3 can allow externally generated static electricity to escape without the need for a shielding electrode, a conductive pad, conductive paste, and so forth similar to Embodiment 4 described below. In addition, similar to Embodiment 2, there is no need for a terminal and opposite electrode wiring to supply a potential to the fifth electrode 15. Therefore, the frame region can be made even narrower. In addition, the materials and manufacturing steps for forming the shielding electrode and so forth are unnecessary, which makes it possible to enhance manufacturing efficiency and reduce manufacturing costs.

According to Embodiment 3, it is possible to achieve a liquid crystal display device having a narrow frame region and high display quality in the same manner as Embodiment 1. In addition, it is possible to maintain even higher display quality because it is harder for static electricity to build up inside the liquid crystal display device.

### Embodiment 4

Embodiment 4 is the same as Embodiment 1 except for additionally having a shielding electrode, a conductive pad, and so forth. Embodiment 4 is preferably used in an IPS, FFS, or other such horizontal electrical field-type liquid crystal display device.

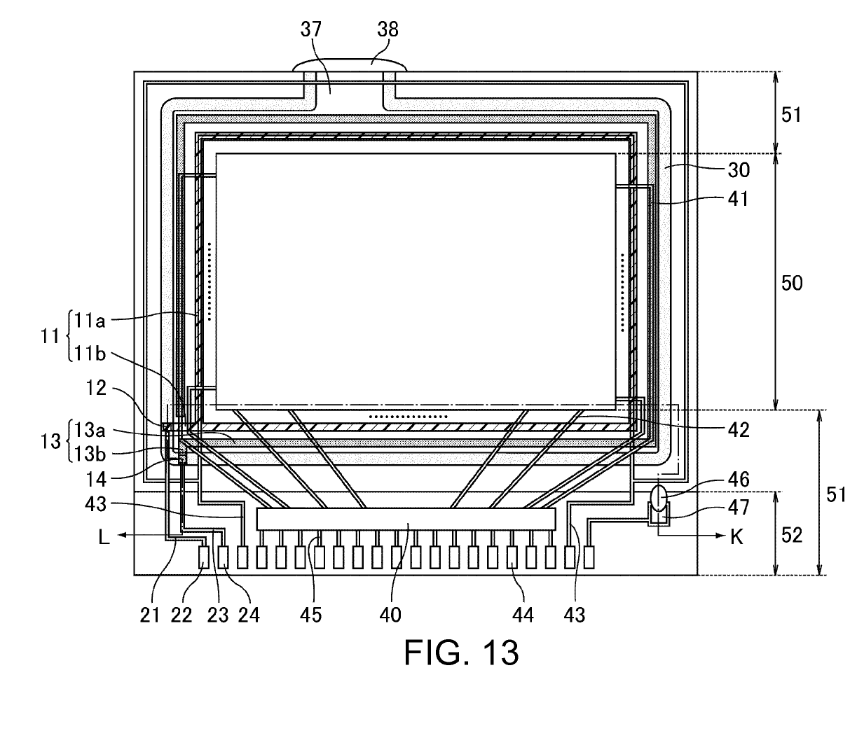

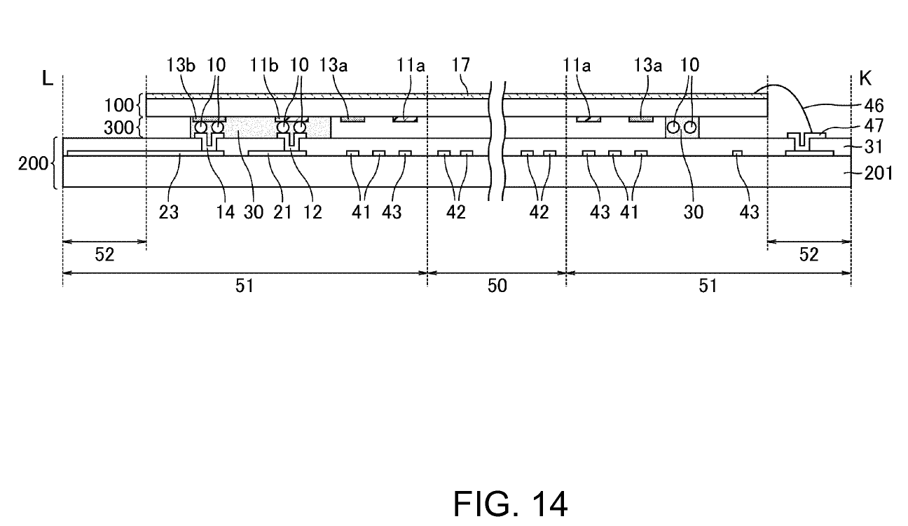

An example of a liquid crystal display device according to Embodiment 4 will be described below. FIG. 13 is a plan view schematically showing the liquid crystal display device according to Embodiment 4. FIG. 14 is a cross-sectional view taken along line K-L of the liquid crystal display device shown in FIG. 13. The same members as those in Embodiment 1 are given the same reference characters, and the description thereof will not be repeated.

As shown in FIG. 14, in Embodiment 4, the color filter substrate 100 has a seventh electrode (shielding electrode) 17 on a surface of the side facing the liquid crystal layer 300. As shown in FIG. 14, the shielding electrode 17 is electrically connected to a conductive pad 47 formed in the terminal region 52 of the array substrate 200 using a conductive paste 46, a conductive tape (not shown), or the like. The supplying of a required potential to the shielding electrode 17 can make it harder for externally generated static electricity to build up inside the liquid crystal display device. A potential that differs from that of the second electrode 12 and/or the fourth electrode 14 is supplied to the shielding electrode 17. It is preferable that the shielding electrode 17 be connected to ground (0V).

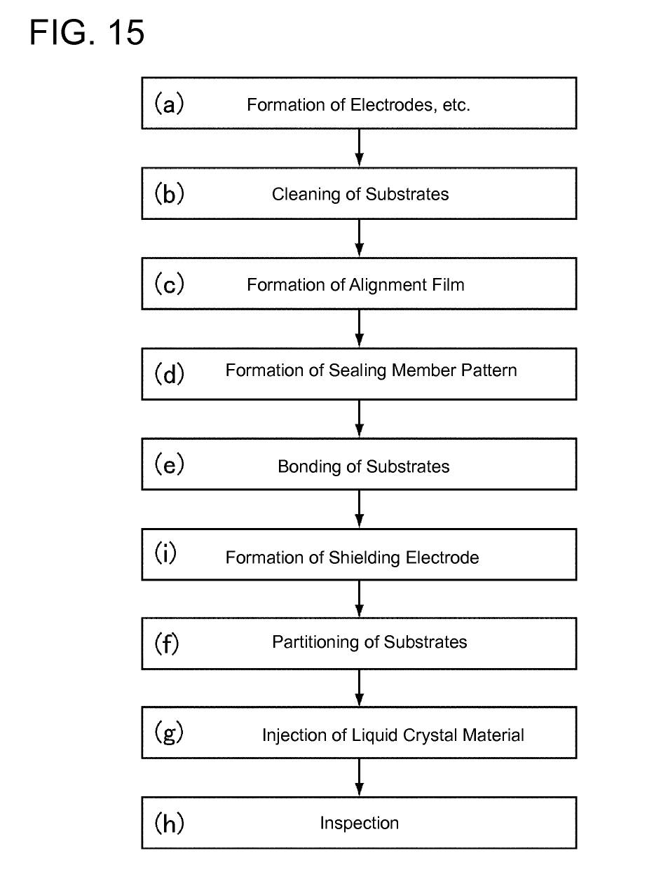

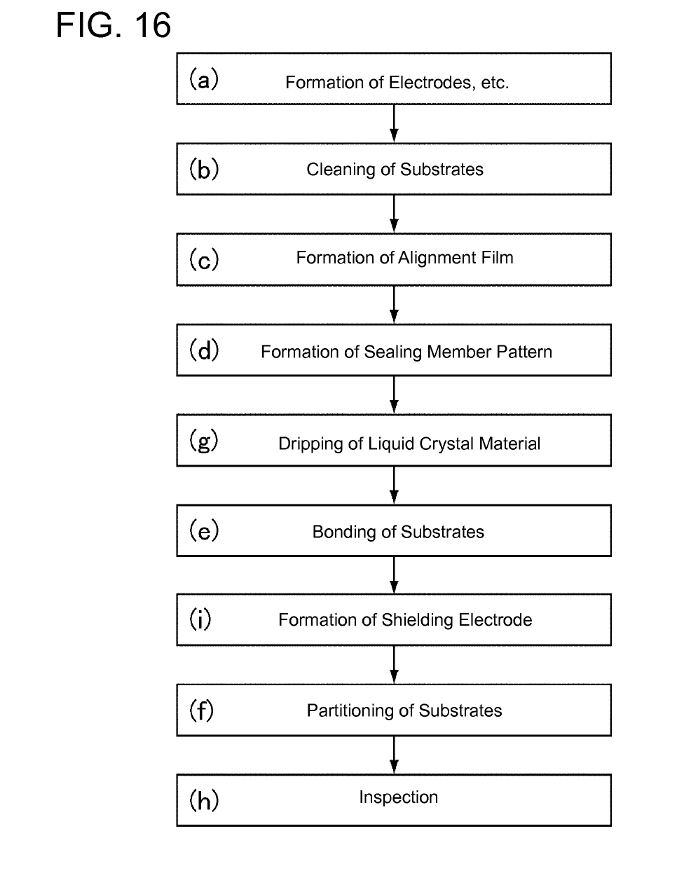

A method of manufacturing the liquid crystal display device according to Embodiment 4 will be explained below using FIGS. 15 and 16. FIGS. 15 and 16 are flowcharts showing steps of manufacturing the liquid crystal display device according to Embodiment 4, FIG. 15 showing manufacturing steps according to a vacuum insertion method, and FIG. 16 showing manufacturing steps according to a liquid crystal dripping method.

As shown in FIG. 15, in the steps of manufacturing according to the vacuum injection method, there is a step (Step (I)) of forming a shielding electrode 17 between the Step (e) of bonding the substrates and Step (f) of dividing the substrates. Steps (a) to (h) are the same as the manufacturing steps according to the vacuum injection method of Embodiment 1 shown in FIG. 3. The shielding electrode 17 is formed using a sputtering method and the like on a surface of the side of the color filter substrate 100 facing the liquid crystal layer 300. The shielding electrode 17 can be formed using ITO, tin dioxide (SnO₂), or other such conductive materials having optical transparency, for example. The shielding electrode 17 is planar, and is formed so as to cover the display region. Silver, carbon past, and the like are preferably used in the conductive paste 46. The conductive pad 47 can be formed using aluminum, copper, or some other conductive material.

In the steps of manufacturing according to the liquid crystal dripping method (ODF), after having formed a pattern using a sealing material so as to surround the display region in one of the substrates without forming a liquid crystal injection opening 37 (Step (d)), as shown in FIG. 16, a liquid crystal material is dripped (Step (g)), and thereafter the liquid crystal layer 300 is formed in accordance with bonding the one substrate to the other substrate (Step (e)). Between Step (e) of bonding the substrates and Step (f) of dividing the substrates, there is a step (Step (i) of forming the shielding electrode 17. Steps (a) to (c), (f) and (h) are the same as the manufacturing steps according to the vacuum injection method of Embodiment 1 shown in FIG. 3.

In Embodiment 4, it is possible to achieve a liquid crystal display device having a narrow frame region and high display quality in the same manner as Embodiment 1. In addition, it is possible to maintain even higher display quality because it is harder for static electricity to build up inside the liquid crystal display device.

Embodiment 4 can be applied to any of Embodiments 1 to 3, and Application Examples 1 and 2.

### Embodiment 5

Embodiment 5 is the same as Embodiment 1 except for using a conductive paste in place of conductive particles as a conductive member.

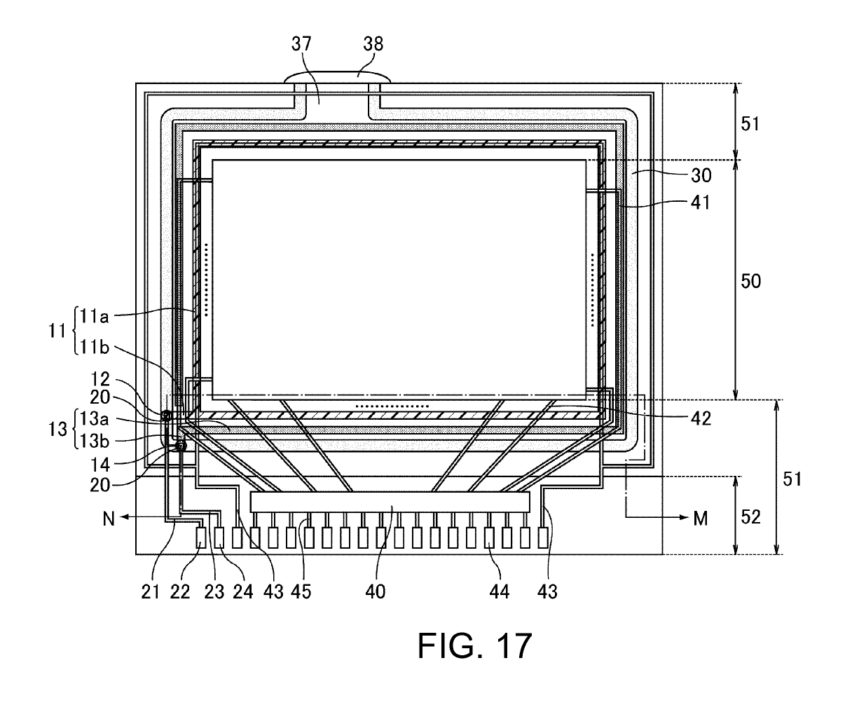

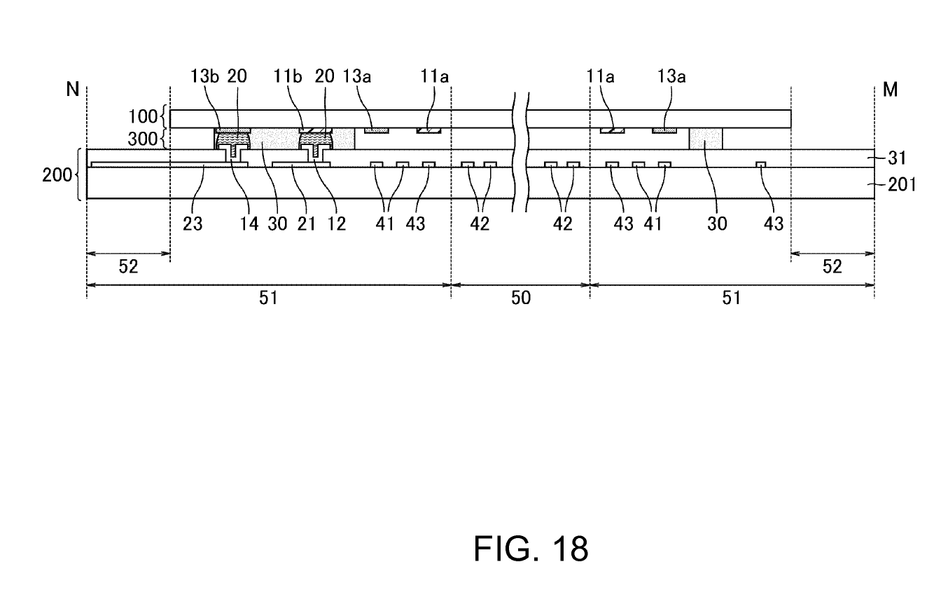

An example of a liquid crystal display device according to Embodiment 5 will be described below. FIG. 17 is a plan view schematically showing the liquid crystal display device according to Embodiment 5. FIG. 18 is a cross-sectional view taken along line M-N of the liquid crystal display device shown in FIG. 17. The same members as those in Embodiment 1 are given the same reference characters, and the description thereof will not be repeated.

As shown in FIGS. 17 and 18, in Embodiment 5, a conductive paste 20 is formed as a conductive member so as to be superimposed on the second electrode 12 and the fourth electrode 14 without the sealing member 30 including conductive particles. The first main wire part 11a is electrically connected to the second electrode 12 via the first lead-out part 11b and the conductive paste (first conductive member) 20. The third main wire part 13a is electrically connected to the fourth electrode 14 via the third lead-out part 13b and the conductive paste (second conductive member) 20.

It is preferable that the conductive paste 20 be formed so as to be wider in width than the second electrode 12 and the fourth electrode 14, and narrower in width than the sealing member 30. Silver, carbon paste, and the like are preferably used in the conductive paste 20.

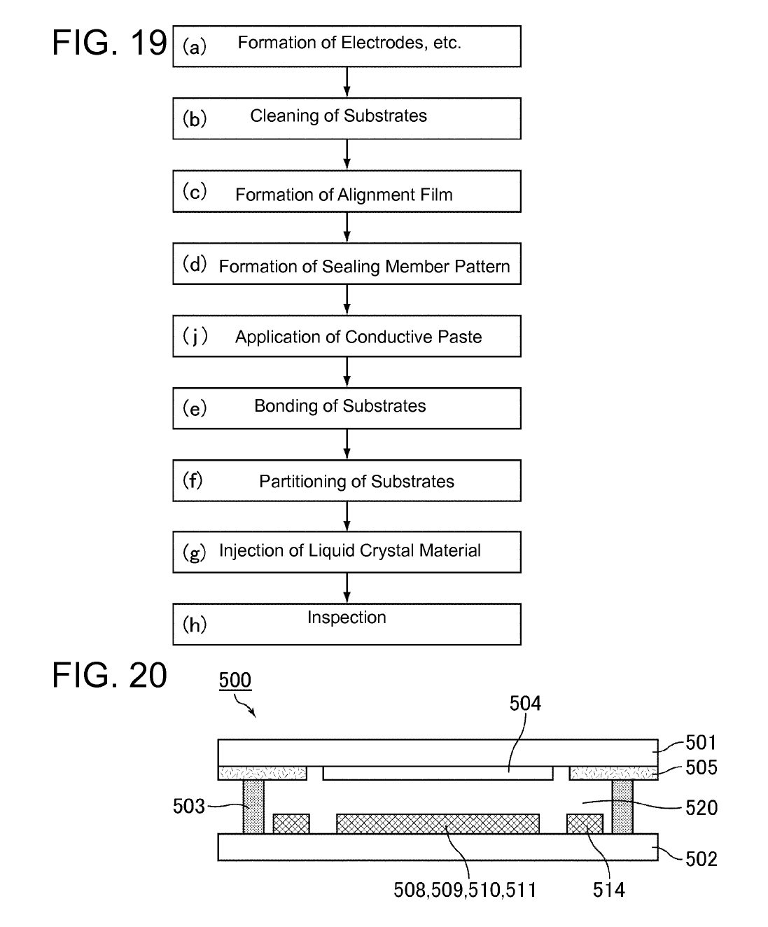

A method of manufacturing the liquid crystal display device according to Embodiment 5 will be explained using FIG. 19. In Embodiment 5, the vacuum injection method is used. FIG. 19 is a flowchart showing the vacuum injection method-based steps of manufacturing the liquid crystal display device according to Embodiment 5.

As shown in FIG. 19, in Embodiment 5, between the step (Step (d)) of forming a sealing member pattern and Step (e) of bonding the substrates, there is a step (Step (j)) of applying a conductive paste. After forming the sealing member pattern, a paste, such as silver, carbon paste or the like is applied from the top of the sealing member, and thereafter, the substrates are bonded. The conductive paste 20 can be applied using a dispensing method, for example. Steps (a) to (h) are the same as the vacuum injection method-based manufacturing steps of Embodiment 1 shown in FIG. 3.

In Embodiment 5, it is possible to achieve a liquid crystal display device having a narrow frame region and high display quality in the same manner as Embodiment 1.

A conductive paste can be used in place of the conductive particles as the conductive member in Embodiments 1 to 4 and Application Examples 1 and 2 in the same manner as Embodiment 5.

### DESCRIPTION OF REFERENCE CHARACTERS

10 conductive particle
11 first electrode
11a first main wire part
11b first lead-out part
12 second electrode
13 third electrode
13a third main wire part
13b third lead-out part
14 fourth electrode
15 fifth electrode
15a fifth main wire part
15b fifth lead-out part
16 sixth electrode
17 seventh electrode (shielding electrode)
20, 46 conductive paste
21, 23, 25 opposite electrode wiring
22, 24, 26, 44 (FPC) terminal
30, 503 sealing member
31 insulating film
37 liquid crystal injection opening
38 sealing agent
40 driver IC
41 gate line
42 source line
43 common electrode wiring
45 connection wiring
47 conductive pad
50 display region
51 frame region
52 terminal region
100 color filter substrate
200 array substrate
300, 520 liquid crystal layer
500 liquid crystal display device
201, 501, 502 transparent substrate
504 opposite electrode
505 ion adsorption electrode
508 switching element
509 gate signal line
510 source signal line
511 pixel electrode
514 dummy pixel electrode

1. A liquid crystal display device having a display region and a frame region, comprising:
a first substrate and a second substrate that face each other;
a sealing member that bonds said first substrate to said second substrate; and
a liquid crystal layer sealed by said sealing member,
wherein said sealing member is formed so as to surround the display region,
wherein the first substrate has a first electrode and a third electrode within the frame region on a surface of the first substrate facing the liquid crystal layer,
wherein the second substrate has a second electrode and a fourth electrode within the frame region on a surface of the second substrate facing the liquid crystal layer,
wherein the first electrode has a first main wire part and a first lead-out part,
wherein the third electrode has a third main wire part and a third lead-out part,
wherein said first main wire part and said third main wire part are respectively disposed between the sealing member and the display region,
wherein a portion of said first lead-out part, a portion of said second electrode, a portion of said third lead-out part, and a portion of said fourth electrode respectively overlap said sealing member,
wherein said first main wire part is electrically connected to the second electrode via said first lead-out part and a first conductive member,
wherein said third main wire part is electrically connected to the fourth electrode via said third lead-out part and a second conductive member,
wherein said first lead-out part and said second electrode are electrically connected at a location that differs from a connection point of said third lead-out part and said fourth electrode, and
wherein potentials having mutually opposite polarities are respectively supplied to said first electrode and said third electrode.

2. The liquid crystal display device according to claim 1, wherein said second electrode and said fourth electrode each connect to a direct-current power source.

3. The liquid crystal display device according to claim 1,
wherein said sealing member includes a plurality of conductive particles,
wherein said first conductive member is at least one of said plurality of conductive particles, and
wherein said second conductive member is at least one of said plurality of conductive particles.

4. The liquid crystal display device according to claim 1, wherein said first main wire part is formed so as to surround said display region.

5. The liquid crystal display device according to claim 1, wherein said third main wire part is formed so as to surround said display region.

6. The liquid crystal display device according to claim 1, wherein said first main wire part and said third main wire part are disposed in the same layer.

7. The liquid crystal display device according to claim 1,
wherein said first substrate further comprises a fifth electrode within the frame region on a surface of the first substrate facing said liquid crystal layer,
wherein said second substrate further comprises a sixth electrode within the frame region on a surface of the second substrate facing said liquid crystal layer,
wherein said fifth electrode has a fifth main wire part and a fifth lead-out part,
wherein said fifth main wire part is disposed on an outer side of said sealing member,
wherein a portion of said fifth lead-out part and a portion of said sixth electrode respectively overlap said sealing member,
wherein said fifth main wire part is electrically connected to said sixth electrode via said fifth lead-out part and a third conductive member, and
wherein said fifth lead-out part and said sixth electrode are electrically connected at a location that differs from the connection point of said first lead-out part and said second electrode and the connection point of said third lead-out part and said fourth electrode.

8. The liquid crystal display device according to claim 7,
wherein said sealing member includes a plurality of conductive particles, and
wherein said third conductive member is at least one of said plurality of conductive particles.

9. The liquid crystal display device according to claim 7, wherein said sixth electrode is supplied with a potential that differs from that of said second electrode and/or said fourth electrode.

10. The liquid crystal display device according to claim 1,
wherein said first substrate further comprises a fifth electrode on a surface of the first substrate facing the liquid crystal layer,
wherein said fifth electrode has a fifth main wire part and a fifth lead-out part,
wherein said fifth main wire part is disposed on an outer side of said sealing member,
wherein a portion of said fifth lead-out part overlaps said sealing member, and
wherein said fifth electrode is electrically connected to either said second electrode or said fourth electrode via said fifth lead-out part and a third conductive member.

11. The liquid crystal display device according to claim 10,
wherein said sealing member includes a plurality of conductive particles, and
wherein said third conductive member is at least one of said plurality of conductive particles.

12. The liquid crystal display device according to claim 7, wherein said fifth main wire part is formed so as to surround the display region.

13. The liquid crystal display device according to claim 7, wherein said fifth main wire part is disposed in the same layer as said first main wire part and said third main wire part.

14. The liquid crystal display device according to claim 1,
wherein said first substrate further comprises another electrode on a surface of the first substrate opposite to said liquid crystal layer, and
wherein the other electrode is supplied with a potential that differs from that of said second electrode and/or said fourth electrode.

15. The liquid crystal display device according to claim 1, wherein said second substrate further comprises a common electrode and a pixel electrode in the display region.
